(19) United States
(12) Patent Application Publication
(10) Pub. No.: US 2003/0135377 A1
(43) Pub. Date: Jul. 17, 2003

(54) Method for detecting frequency in an audio signal

(76) Inventors: Shai Kurianski, Ramat Hasharon (IL); Assaf Friedler, Ramat Efal (IL)

Correspondence Address: G.E. EHRLICH (1995) LTD., c/o ANTHONY CASTORNA, SUITE 207, 2001 JEFFERSON DAVIS HIGHWAY, ARLINGTON, VA, 22202, US

(21) Appl. No.: 10/323,629

(22) Filed: Dec. 20, 2002

Related U.S. Application Data
(60) Provisional application No. 60/346,985, filed on Jan. 11, 2002.

(51) Int. Cl. G10L 19/00

(52) U.S. Cl. 704/500

(57) ABSTRACT

A method for identifying digital music files that match a input signal bearing auditory information. An input signal is received and processed to extract basic musical information. The basic musical information is compared to musical information corresponding to digital music files, in order to identify digital music files that match the input signal.

### RELATIONSHIP TO EXISTING APPLICATIONS

The present application claims priority from U.S. Provisional Application No. US60/346,985, filed Jan. 11, 2002, the contents of which are hereby incorporated by reference.

### FIELD OF THE INVENTION

The present invention relates to a method for detecting frequency in an audio signal and more particularly but not exclusively to a method for identifying computer digital music files that match an audio input signal.

### BACKGROUND OF THE INVENTION

The development of computerized information resources, such as remote networks, allow users of data-processing systems to link with other servers and networks, and thus retrieve vast amounts of electronic information heretofore unavailable in an electronic medium. Such electronic information is increasingly displacing more conventional means of information transmission, such as newspapers, music, magazines, and even television.

One remote network commonly utilized in recent years is the Internet. The Internet can be described as a system of geographically distributed remote computer networks interconnected by computers executing networking protocols that allow users to interact and share information over the networks. The Internet is stocked with content on an extremely wide variety of subjects. When individuals connect to the Internet they are faced with the problem of locating information of specific interest to themselves.

In response to this problem, Internet search engines have been developed. Internet search engines make it simple to track down sites where an individual can obtain information on a topic of interest. A person types keywords relating to a subject of interest, and the search engine generates a list of network sites that match these keywords. With a little practice, even new users can skim millions of web pages or thousands of newsgroups, not only for topics of general interest, but also to access precise bits of data. The markets for Internet access and related applications are explosive and are growing faster than expected, doubling in size approximately every three months.

Today users are searching the Internet for a new type of media, music files. Music files are available for download or purchase on the Internet in a variety of formats. One well-known format is MP3, a compressed, high-quality audio file. It has become so popular that a wide variety of music is available in this format. Music fans can download the file from the Internet onto their personal computer. But first they must locate the file they want.

Prior art music search engines require the user to supply keywords such as the name of the song, the artist, or song lyrics. Currently, most music search engines cannot help a user who knows only a melody, or a fragment of a song. With these search engines, a user cannot locate a song that he has just heard on the radio, or that he has been humming all morning.

### SUMMARY OF THE INVENTION

According to a first aspect of the present invention there is thus provided a method for detecting the presence of substantially repeating features in a waveform and determining the frequency of a waveform containing the features, comprising the steps of: selecting a feature, detecting the times of occurrence of the feature over a predetermined time interval, calculating the differences of time of occurrence of a predetermined number of consecutive occurrences of the feature, determining if the differences of time of occurrence are substantially equivalent using a predetermined criterion of equivalence, determining that the feature is repetitive if the differences of time of occurrence are substantially equivalent, and if the feature is substantially repetitive, calculating the frequency of the waveform from the differences of time of occurrence.

In a preferred embodiment the method comprises the further step of: sampling the waveform at a predetermined sample rate to determine the amplitude of the waveform at each sample time.

In a preferred embodiment, the feature is the waveform crossing one of a predetermined set of thresholds. In a further preferred embodiment, the feature is a waveform turning point.

According to a second aspect of the present invention there is thus provided a method for identifying computer digital music files that match an input signal bearing auditory information comprising the steps of: receiving an input signal bearing auditory information, processing the input signal to extract input frequency versus time information, for each of the digital music files, processing the file to extract frequency versus time information, comparing the ratio of the input frequency information to the frequency information of respective digital music files over the duration of the input signal to thereby identify a digital music file that most closely matches the input signal.

In a preferred embodiment the step of processing the input signal to extract input frequency versus time information further comprises: sampling the waveform at a predetermined sample rate to determine the amplitude of the waveform at each sample time, detecting the times of occurrence of a predetermined repeating feature over a predetermined time interval, calculating the differences of time of occurrence of a predetermined number of consecutive occurrences of the feature, determining if the differences of time of occurrence are substantially equivalent using a predetermined criterion of equivalence, if the differences of time of occurrence are substantially equivalent, calculating the frequency of the time interval by dividing the difference of time of occurrence by the sample frequency, and compiling a listing of the frequency of the waveform against time for a duration of the waveform.

In an alternate preferred embodiment the step of processing the input signal to extract input frequency versus time information comprises: sampling the waveform at a predetermined sample rate to generate a sampled waveform series of elements, each element comprising a magnitude of the input signal, if the elements are of equivalent magnitudes, setting the cycle length equal to zero and discontinuing the frequency extraction process; and if the elements are not of equivalent magnitudes, performing the steps of: setting a test waveform equal to the sampled waveform series; and performing a frequency extraction iteration cycle.

A frequency extraction cycle comprises the steps of: detecting turning point elements of the test waveform vector at which the test waveform vector changes direction, determining a pair of turning points having the largest difference in magnitude, such that no other turning point value falls between the pair of turning points, selecting a threshold by calculating an average of the pair of turning points, generating a position series, wherein each element of the position series is a position at which lines between successive pairs of elements of the test waveform cross the threshold, and wherein the order of the elements in the position series is preserved relative to the test waveform, generating a position difference series, wherein each element of the position difference series comprises a difference between a respective pair of successive elements of the position series, if the position difference sequence comprises fewer than five elements, setting the cycle length equal to zero and discontinuing the frequency extraction process, if the position difference sequence comprises more than four elements and the elements are of equivalent magnitudes, calculating a cycle length of the sampled waveform and discontinuing the frequency extraction process, and if the position difference sequence comprises more than four elements and the elements are not of equivalent magnitudes, continuing the frequency extraction process by performing the steps of: storing the position difference series, setting the test waveform series equal to the position difference series, and performing a frequency extraction iteration cycle.

In a preferred embodiment, the step of calculating a cycle length of the sampled waveform comprises: setting a proposed cycle length equal to two, and performing a cycle length determination iteration. A cycle length determination iteration is performed by: recursively calculating from the stored position difference series a number of sampled waveform elements represented by the proposed cycle length, generating a test vector by subtracting one cycle of the sampled waveform series from a second cycle shifted by the proposed cycle length, if the test vector is equivalent to a zero vector, discontinuing the cycle length calculation process by setting the cycle length equal to the number of sampled waveform elements, and if the test vector is not equivalent to a zero vector, incrementing the proposed cycle length by one and performing another cycle length determination iteration.

In a preferred embodiment, the input signal comprises a sampled waveform series.

In a preferred embodiment the method comprises the further step of determining a frequency of the input signal from the cycle length.

In a further preferred embodiment, the input signal is generated by a user.

In a further preferred embodiment, the input signal is generated by a user humming.

In a further preferred embodiment, the input signal is generated by a user singing.

In a further preferred embodiment, the input signal is generated by a musical instrument.

In a further preferred embodiment, the input signal is a computer sound file.

In a preferred embodiment, digital music files are located on a computer network.

In a further preferred embodiment, at least one of the digital music files comprises a mobile telephone ring tone file.

In a preferred embodiment, the step of comparing the ratio of the input frequency information to the frequency information corresponding to each of the digital music files further comprises: calculating the ratio between the input frequency to the digital music file frequency over the duration of the input, calculating the average of the ratio and the deviation of the ratio from the average ratio, and determining the degree to which the input signal matches the digital music file, wherein a small deviation of the ratio indicates a strong match and a large deviation of the ratio indicates a weak match.

In a further preferred embodiment, the step of comparing the ratio of the input frequency information to the frequency information corresponding to each of the digital music files further comprises: multiplying the time dimension of the input frequency versus time information by a predetermined factor.

In a preferred embodiment, the step of multiplying the time dimension of the input frequency versus time information by a predetermined factor further comprises: for each digital music file, varying the predetermined factor to identify an optimal factor that results in the closest match between the modified input signal information and the music file.

In a further preferred embodiment, the step of comparing the ratio of the input frequency information to the frequency information corresponding to each of the digital music files further comprises: for each digital music file, multiplying the time dimension of the input frequency versus time information by the optimal factor for the digital music file.

In a further preferred embodiment, the step of comparing the ratio of the input frequency information to the frequency information corresponding to each of the digital music files further comprises: delaying the input frequency versus time information by a predetermined offset.

In a preferred embodiment, the step of delaying the input frequency versus time information by a predetermined offset further comprises: for each digital music file, varying the predetermined offset to identify an optimal offset that results in the closest match between the modified input signal information and the music file.

In a further preferred embodiment, the step of comparing the ratio of the input frequency information to the frequency information corresponding to each of the digital music files further comprises: for each digital music file, delaying the input frequency versus time information by the optimal offset for the digital music file.

In a preferred embodiment, the input signal serves as a search parameter for a music files search engine that identifies digital music files that match the input signal.

In a preferred embodiment the method comprises the further step of: processing the digital music files to automatically extract musical note versus time information.

In a preferred embodiment the method comprises the further step of: processing the input signal to extract input musical note versus time information.

In a preferred embodiment the method comprises the further step of: comparing the input musical note versus time information with musical note versus time information corresponding to the digital music files to thereby identify a digital music file that matches the input signal.

In a further preferred embodiment, the input signal is compared to musical scores associated with the digital music files.

In a further preferred embodiment, a best match comparison is performed between the input signal and the digital music files, to determine the closest match.

In a further preferred embodiment, the comparison between the input signal and the digital music files produces a list of files wherein the list indicates the degree to which the files match.

According to a third aspect of the present invention there is thus provided a method for identifying digital music files that match a computer file, wherein the computer file represents a segment of a musical score, comprising the steps of: processing the computer file to extract frequency versus time information; processing the digital music files to extract frequency versus time information, and comparing the frequency versus time information corresponding to the computer file to frequency versus time information corresponding to the digital music files to thereby identify a digital music file that matches the segment of a musical score.

According to a fourth aspect of the present invention there is thus provided a method for generating a digital music file, comprising the steps of: receiving an input signal bearing auditory information, processing the input signal to extract input frequency versus time information, and generating a digital music file from the frequency versus time information extracted from the input signal. The input signal is processed to extract input frequency versus time information by: sampling the waveform at a predetermined sample rate to generate a sampled waveform series of elements, each element comprising a magnitude of the input signal, if the elements are of equivalent magnitudes, setting the cycle length equal to zero and discontinuing the frequency extraction process, and if the elements are not of equivalent magnitudes, performing the steps of: setting a test waveform equal to the sampled waveform series, and performing a frequency extraction iteration cycle.

A frequency extraction iteration cycle is performed by: detecting turning point elements of the test waveform vector at which the test waveform vector changes direction, determining a pair of turning points having the largest difference in magnitude, such that no other turning point value falls between the pair of turning points, selecting a threshold by calculating an average of the pair of turning points, generating a position series, wherein each element of the position series is a position at which lines between successive pairs of elements of the test waveform cross the threshold, and wherein the order of the elements in the position series is preserved relative to the test waveform, generating a position difference series, wherein each element of the position difference series comprises a difference between a respective pair of successive elements of the position series, if the position difference sequence comprises fewer than five elements, setting the cycle length equal to zero and discontinuing the frequency extraction process, if the position difference sequence comprises more than four elements and the elements are of equivalent magnitudes, calculating a cycle length of the sampled waveform and discontinuing the frequency extraction process, and if the position difference sequence comprises more than four elements and the elements are not of equivalent magnitudes, continuing the frequency extraction process by performing the steps of: storing the position difference series, setting the test waveform series equal to the position difference series, and performing a frequency extraction iteration cycle.

In a preferred embodiment, the input signal is generated by a user.

In a further preferred embodiment, the input signal is generated by a user humming.

In a further preferred embodiment, the input signal is generated by a user singing.

In a preferred embodiment, the digital music files comprises a mobile telephone ring tone file.

According to a fifth aspect of the present invention there is thus provided an apparatus for detecting the presence of substantially repeating features in a waveform and determining the frequency of a waveform containing the features, comprising: a waveform sampler operable to sample the waveform at a predetermined sample rate to determine the amplitude of the waveform at each sample time, a feature detector operable to detect times of occurrence of repeating features over a predetermined time interval, a subtractor operable to calculate differences between successive ones of the times of occurrence, an equivalency detector operable to determine if the differences of time of occurrence are substantially equivalent using a predetermined criterion of equivalence, and thereby determine that the features are substantially repetitive if the differences of time of occurrence are substantially equivalent, and a frequency calculator operable to calculate the frequency of the time interval by dividing the difference of time of occurrence by the sample frequency.

A preferred embodiment further comprises a tabulator operable to compile a listing of the frequency versus time information of the waveform for the entire duration of the waveform.

In a preferred embodiment, the waveform is stored on a computer file.

According to a sixth aspect of the present invention there is thus provided an apparatus for comparing the frequency versus time information of an input signal to the frequency information corresponding to a digital music file over the duration of the input signal to thereby identify if the digital music file matches the input signal, comprising: a ratio calculator operable to calculate the ratio of the input frequency information to the frequency information corresponding to the digital music file over the duration of the input signal, a statistics calculator operable to calculate an average of the ratio and a deviation of the ratio from the average ratio, and a signal matcher operable to determine the degree to which the input signal matches the digital music file, wherein a small deviation of the ratio from the average indicates a strong match and a large deviation of the ratio from the average indicates a weak match.

A preferred embodiment further comprises: a time multiplier operable to multiply the time dimension of the input signal frequency versus time information by a predetermined factor, and a time multiple adjuster operable to vary the factor to identify an optimal factor that results in the closest match between the modified input signal information and the music file.

A further preferred embodiment further comprises: a delayer operable to delay the time dimension of the input signal frequency versus time information by a predetermined offset, and an offset adjuster operable to vary the offset to identify an optimal offset that results in the closest match between the modified input signal information and the music file.

According to a seventh aspect of the present invention there is thus provided a music files search engine, comprising: an input device for obtaining an input signal, a music signal processor operable to extract musical information, and a signal matcher operable to determine the degree to which extracted input signal musical information matches extracted digital music file musical information, and wherein the music files search engine is operable to search a plurality of music files for the files that match the input signal most closely.

Preferably the digital music files are located on a computer network.

Preferably at least one of the digital music files comprises a mobile telephone ring tone file.

### BRIEF DESCRIPTION OF THE DRAWINGS

For a better understanding of the invention and to show how the same may be carried into effect, reference will now be made, purely by way of example, to the accompanying drawings, in which:

FIG. 1 is a block diagram of a system for identifying digital music files that match a musical input signal.

FIG. 2 is a simplified flow chart of an embodiment of an algorithm to determine audio signal frequency over time.

FIG. 3 shows an example of a musical input signal.

FIG. 4 is a simplified flow chart of an alternate preferred embodiment of an algorithm to determine a frequency of an input signal over time.

FIG. 5 is a simplified flow chart of a preferred embodiment of an algorithm for calculating a cycle length of a sampled waveform

FIG. 6 shows a sampled input waveform a position difference series derived therefrom.

FIG. 7 shows an example of a musical input signal at several tempos.

FIG. 8 shows a segment of a musical signal at different time offsets from the beginning of the complete musical signal.

FIG. 9 is a simplified flow chart of a preferred embodiment of an algorithm to determine the strength of the match between an input signal and a given digital music file.

FIG. 10 is a simplified block diagram of a system for identifying digital music files that match a computer sound file.

FIG. 11 is a simplified block diagram of a music files search engine.

FIG. 12 is a simplified block diagram of an apparatus for determining the frequency of an input signal over time.

FIG. 13 is a simplified block diagram of an apparatus for comparing the frequency versus time information of an input signal to the frequency information corresponding to a digital music file in order to identify if the digital music file matches the input signal.

FIG. 14 is a simplified block diagram of a music files search engine.

FIG. 15 is a simplified flow chart of a preferred embodiment of a method for generating a digital music file from an input signal.

### DESCRIPTION OF THE PREFERRED EMBODIMENTS

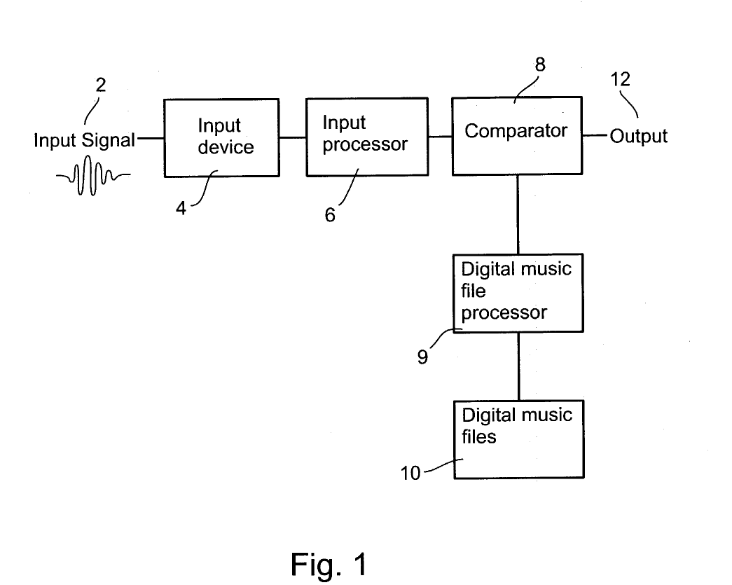

Reference is now made to FIG. 1, which is a simplified block diagram of a preferred embodiment for identifying digital music files that match an input signal containing musical information. Input signal 2, for matching, enters input device 4, and is converted into a signal that is suitable for input processor 6, typically by digitizing. Input processor 6 processes the input signal to obtain essential musical information, as will be described in greater detail below, and conveys the input signal musical information to comparator 8. Similarly, digital music file processor 9 processes digital music files 10 to obtain essential musical information, and conveys music file musical information to comparator 8. Comparator 8 compares the information received from the input processor 6 with the information received from the digital music file processor 9, in order to determine the degree to which they match. The digital music files 10 may be located on any device accessible to digital music file processor 9, such as a local computer or a computer network. In a preferred embodiment, comparator 8 outputs, for example, a list of files ranked according to matching with the segment, or the matching files accompanied by an indication of the closeness of the match. In an embodiment, the files are made available for the user to download to a local computer.

Input signal 2 may be from any one of a plurality of sources. The input signal may be generated by a variety of sources, such as a user, musical instrument, cellular telephone, personal digital assistant, or any other device or instrument capable of generating an audio signal or of generating a representation of an audio signal. In the present embodiment the input signal is an auditory signal, such as a person singing or humming, or a song played on a musical instrument. Consequently, input device 4 is a microphone. In another embodiment, the input signal is generated directly by input device 4, for example, a musical instrument with an electronic output, such as a keyboard. In another embodiment, described in more detail below, the input signal is a digital file representing a musical signal, and the input device is a memory device, such as a computer hard drive.

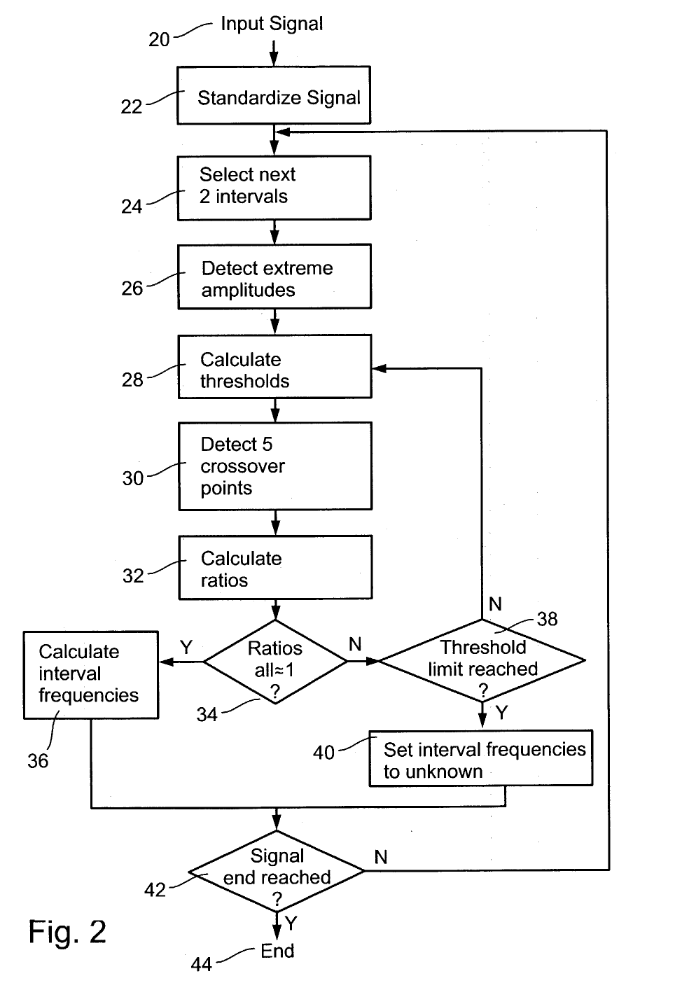

Reference is now made to FIG. 2, which is a simplified flow chart of a first preferred embodiment of an algorithm performed by the input processor 6 to determine a frequency of the input signal over time. The processor first converts the input signal 20 into standardized form in step 22. In the present embodiment, where the input is an analog auditory signal, input processor 6 performs analog to digital conversion of the input signal, converting the audio signal received from the input device 4 into a digital format. Then the processor divides the signal into consecutive time intervals, and examines the signal over adjacent pairs of intervals to determine its frequency at each time interval, as will be described in greater detail.

In another embodiment the processor additionally determines the signal tone at each interval. Comparator 12 may then use the signal tone information to help determine the degree to which the input signal and a digital music file match.

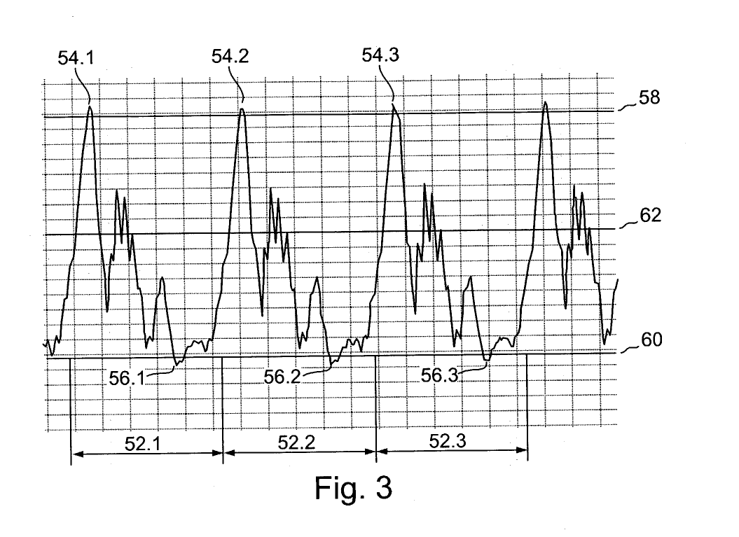

Reference is now made to FIG. 3, which is a simplified graph of signal amplitude over time for several intervals of an input signal. The x-axis of the graph is the time axis, and the y-axis of the graph is the amplitude axis. The signal is divided into time intervals, 52.1, 52.2, and 52.3. Three amplitude thresholds are displayed on the graph, an upper threshold 58, lower threshold 60, and middle threshold 62. Several points at which the signal crosses the upper threshold are marked 54, and points at which the signal crosses the lower threshold are marked 56.

In a preferred embodiment the algorithm used to determine the signal frequency processes adjacent pairs of intervals. Returning now to FIG. 2, the algorithm for a given pair of time intervals is as follows. After the input signal 20 is converted into standardized form in step 22, the signal time intervals to be analyzed are selected in step 24. The analyzer detects the upper and lower extreme amplitudes of the signal in the given intervals in step 26. For example, referring to FIG. 3, in interval 52.1 the upper extreme amplitude is 54.1 and the lower extreme is 56.1. Returning now to FIG. 2, thresholds are calculated from the extreme values in step 28. In the present embodiment, the upper threshold 58 and lower threshold 60 are extracted from the extreme values by multiplying them by a certain percentage. In the present example the thresholds are taken to be 97% of the peak values.

After the thresholds are set, times at which the signal crosses the thresholds are detected in step 32. The following five times are determined for the intervals currently being analyzed in step 30:

A: the first time one of the thresholds is crossed (in the present example denoted 54.1 in FIG. 3)

B: the first time the opposite threshold is crossed (in the present example denoted 56.1 in FIG. 3)

C: the second time the first threshold is crossed (in the present example denoted 54.2 in FIG. 3)

D: the second time the opposite threshold is crossed (in the present example denoted 56.2 in FIG. 3)

E: the third time the first threshold is crossed (in the present example denoted 54.3 in FIG. 3)

If the times are found to be occurring regularly, the signal frequency may be extracted for the current interval. Regularity is determined by calculating the following four ratios in step 32:

1. (B−A)/(D−C)

2. (E−C)/(C−A)

3. (E−C)/(D−B)

4. (C−A)/(D−B)

The processor checks if the four ratios are all approximately equal to one in step 34. If they are, the frequencies for two intervals are calculated in step 36. The first interval begins at time A and ends at time C. The frequency detected for the first interval is (C−A) divided by the sample rate. The second interval begins at time C and ends at time E. The frequency detected for the second interval is (E−C) divided by the sample rate. The processor then proceeds to the next pair of time intervals in step 24, and repeats the algorithm to detect the frequencies of the next pair of intervals.

If the calculated ratios are not all approximately equal to one, the processor checks if the threshold limit has been reached in step 38. If the limit has not been reached, the processor calculates a new threshold, to seek a threshold at which a frequency can be detected in step 28. If the thresholds have been checked over the entire range of permissible values and no frequency has been detected for the intervals being checked, the interval frequency is left undetermined in step 40, and the processor proceeds to the next interval in step 24. The process described above is repeated until the end of the signal is reached in step 42, and the algorithm terminates 44.

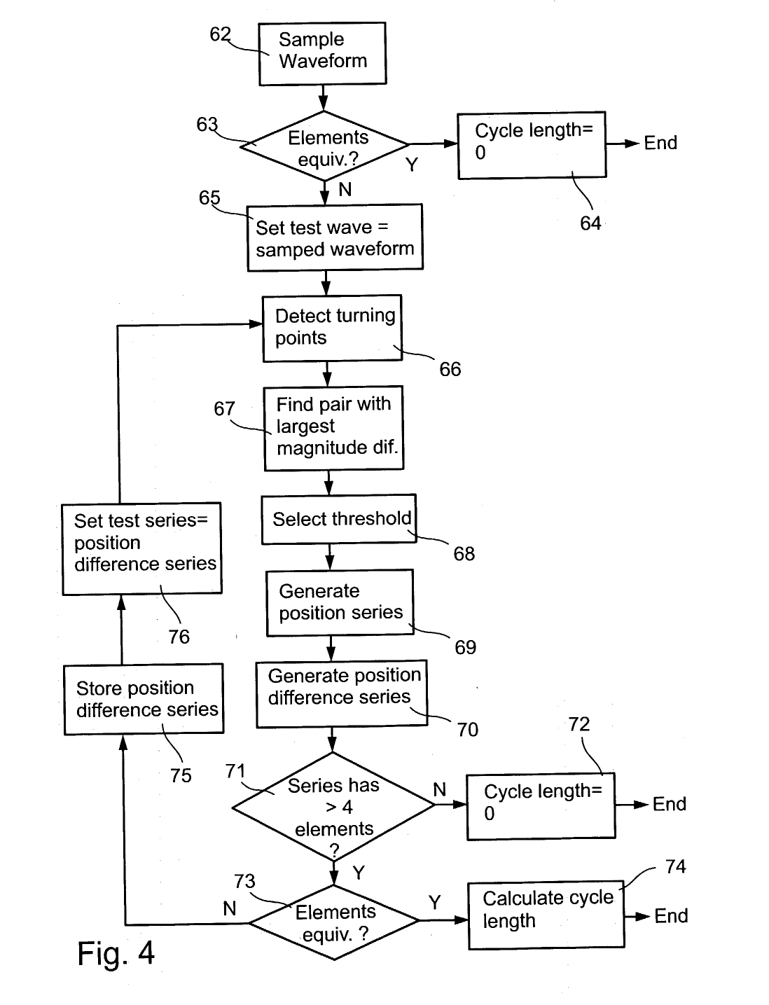

Reference is now made to FIG. 4, which is a simplified flow chart of an alternate preferred embodiment of an algorithm performed by the input processor 6 to determine a frequency of the input signal over time. The input signal is analyzed to identify a cycled signal, where a cycled signal is a signal containing fixed length repeating segments (i.e. <Cycle><Cycle><Cycle> . . . <Cycle>), and where the cycle length is greater than 1. The algorithm logic does not seek for harmonics, and cannot replace and/or be replaced by FFT or similar methods. After the algorithm determines that a signal is cycled, a cycle length is calculated. In the preferred embodiment, the signal frequency calculated from the cycle length. An example illustrating the operation of the algorithm is given below.

In step 62 the input waveform is sampled at a predetermined sample rate to generate a sampled waveform series. In the case where in input waveform in a sampled signal, this step may not be required. Each element of the series is comprises a magnitude of the input signal. In step 63 the relative magnitudes of the sample elements are examined. If the elements are of equivalent magnitudes, the cycle length is set to zero to indicate that the input signal is not a cycled signal in step 64, and the frequency extraction process is discontinued.

If the elements are not of equivalent magnitudes, in step 65 a test waveform series is created and set equal to the sampled waveform series. The algorithm then enters an iterative frequency iteration loop in step 66. The goal of the iterative process is to reduce the complexity of the input signal and thereby uncover an underlying cyclic component.

In step 66 turning point elements of the test waveform vector are detected. A turning point element is a sample at which the test waveform vector changes direction, as shown in FIG. 6a. A pair of turning points having the largest difference in magnitude is determined in step 67. This pair is selected such that no other turning point value falls between the chosen pair of turning points. A threshold is selected in step 68, by calculating an average of the magnitudes of the selected pair of turning points.

Once the threshold is calculated, a position series is generated in step 69. Each element of the position series is a position at which lines between successive pairs of elements of the test waveform cross the selected threshold, as illustrated in the example below. In step 70, a position difference series is generated from the position series. Each element of the position difference series comprises a difference between a respective pair of successive elements of the position series.

In step 71, the position difference series is tested to determine the number of elements in the position difference series. If the position difference sequence comprises up to four elements, the cycle length equal to zero to indicate it is not a cycled signal in step 72, and the frequency extraction process is discontinued. If the position difference sequence comprises more than four elements, the relative magnitudes of the elements in the series are tested in step 73. If the elements are of equivalent magnitudes, a cycle length of the sampled waveform is calculated in step 74, and the frequency extraction process is ended.

If the position difference sequence comprises more than four elements and the elements are not of equivalent magnitudes, the frequency extraction process is continued. The position difference series is stored in step 75, and the test waveform series is set equal to the position difference series in step 76. The frequency extraction iteration process is then reentered in step 66.

The frequency extraction algorithm operates under the assumption that the position difference vector generated for a cycled input waveform by a frequency extraction loop will be cycled as well. The cycle length of the original input waveform signal is equal to the sum of the elements in one cycle of the position difference vector. Thus, after performing the position difference vector generation process N times on a cycled input waveform, where N is a positive integer larger than one, a signal having samples of equivalent magnitudes will eventually be generated. A series where all signal elements have equivalent magnitudes is denoted a target signal. If a target signal is not generated, the algorithm returns that the input waveform is not a cycled signal.

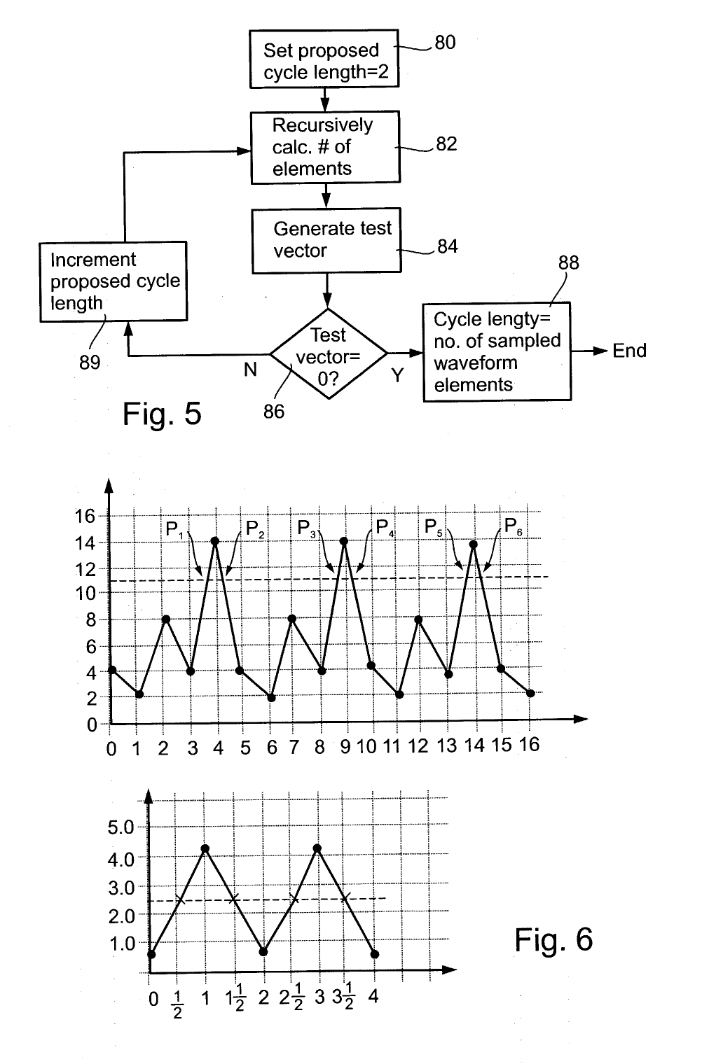

Reference is now made to FIG. 5, which is a simplified flow chart of a preferred embodiment of an algorithm for calculating a cycle length of the sampled waveform. Once a target-signal is reached, the algorithm determines the original input signal's cycle length by gradually increasing a proposed cycle length. The input waveform properties are tested utilizing the proposed cycle length, until the correct cycle length is discovered.

First a proposed cycle length is set equal to two in step 80. In step 82 the cycle length determination iteration process is entered by recursively calculating the number of sampled waveform elements represented by the proposed cycle length from the position difference series stored during the frequency extraction process described above. In step 84 a test vector is generated by subtracting one cycle of the sampled waveform series from a second cycle shifted by the proposed cycle length. The test vector is examined in step 86. If the test vector is equivalent to a zero vector, in step 88 the waveform cycle length is set equal to the calculated number of sampled waveform elements (from step 82), and the cycle length calculation process is ended. If the test vector is not equivalent to a zero vector, the proposed cycle length incremented by one in step 89, and another cycle length determination iteration is performed.

A cyclic input signal may not repeat itself exactly from cycle to cycle. In the preferred embodiment, a test vector is equivalent to a zero vector if all elements of the test vector are less than a predetermined value. In the preferred embodiment, a similar criterion is used to determine if a given series comprises a target signal. According to the preferred embodiment, a series is a target series if the magnitude of all elements of the series fall within a predetermined range.

Reference is now made to FIG. 6a which shows a sampled input waveform, and FIG. 6b which shows the position difference series derived from the input waveform of FIG. 6a. The example below illustrates the steps of the above algorithms, and how the cycle length of the waveform of FIG. 6a may be determined. The elements of the sampled input waveform are {4,2,8,4,14,4,2,8,4,14 . . . }. The turning point elements are 2, 4, 8, and 14, as marked on FIG. 6a. Of these turning points, the pair of consecutive turning points having the maximum difference between them is (14,8). Calculating the average of these points gives a threshold of:

(14+8)/2=11.

This threshold is shown on FIG. 6a.

Once a threshold is calculated, the position series can be calculated. The position series is a vector of the positions at which lines connecting the input waveform samples cross the threshold. In the current example the position series P1 is: {3.7, 4.3, 8.7, 9.3, 13.7, 14.3 . . . }.

The position difference series is generated from the position series by calculating the difference between each element of the position series and the subsequent element. The resulting position difference sequence PD1 is thus: {0.6, 4.4, 0.6, 4.4, 0.6} as shown in FIG. 6b.

Since the position difference sequence found is not a target series, the position difference sequence is stored for use during the cycle length determination algorithm, and a new iteration loop is entered using the generated position difference sequence as an input. In the second iteration, each point of the input sequence is a turning point. Thus the threshold is:

(0.6+4.4)/2=2.5

as these are the only two turning point values. The new position series, P2 is {0.5, 1.5, 2.5, 3.5} and the new position difference vector, PD2, is {1, 1, 1, 1}. A target signal has been reached.

The next step of the algorithm is to calculate a cycle length. In the first iteration of the cycle length calculation algorithm, a cycle length of 2 is proposed. The cycle length of the input waveform vector calculated from the proposed length is:

PD1[0]+PD1[1]=0.6+4.4=5 samples.

The proposed cycle length is tested by subtracting the elements comprising one proposed cycle of the input waveform from the elements of the subsequent cycle, to determine if the two cycles are equivalent. Examining the input vector shows that the proposed cycle length is correct. The vector elements repeat every five samples. If the proposed cycle length had proven incorrect, the proposed cycle length would have been incremented and the algorithm performed again assuming that PD2(3) cycles are 3 samples long. The process continues until the underlying cycle in the input waveform is uncovered.

Returning to FIG. 1, the algorithm used by digital music file processor 9 differs according to the type of music file being processed. The music file may represent the music in a several ways, for example as a digitized audio signal, a ring tone, or a musical score. The digital music file processor 9 analyzes the digital music files to extract frequency, and optionally tone, information from the digital music files. In one preferred embodiment the music file 10 being processed is a MIDI file. The MIDI file type stores the musical score information as a sequence of notes. Each note has a corresponding frequency. For example, middle A is 440 Hz, and the ratio between adjacent notes is 2^{1/6}. For each time interval, the music file processor 9 reads the corresponding note from the file, and calculates its frequency. In another embodiment, the music file 10 being processed is a WAV or MP3 file. File types such as WAV and MP3 store the raw audio data, and a number of other parameters such as the sample rate, and bit depth. For files that store the raw audio data, the music file processor 9 uses an algorithm to process the raw audio data that is similar to the algorithm used by the input processor 6.

Once the input signal and the music file have been processed, comparator 8 compares the input signal frequency information received from the input processor 6 to the music file frequency information received from the music file processor 9. The comparison results determine how closely the input signal matches the music file. A preferred embodiment of the algorithm used by comparator 8 compares signal frequencies over time rather than signal notes over time. Comparing signal frequencies generally provides greater accuracy, since the user signal frequency generally will not fall exactly on a musical note. Converting the user signal to notes requires rounding of the user frequency to the note frequency, thereby introducing distortion into the signal. This type of distortion may be avoided by comparing signal frequencies directly.

Musical notes differ from each other on a logarithmic scale. Twelve notes make up an octave, and the frequency of each note in an octave is twice the frequency of the same note in the previous octave. For example, the frequency of middle A is 440 Hz, and the frequency of high A is 880 Hz. For this reason, the preferred embodiment of the comparator algorithm therefore compares the ratio of the input signal frequency to the music file frequency for every time interval. The comparator calculates the average ratio (AV), and the average offset (AVO) of the exact input to music file ratio from the AV over the duration of the input signal. The AVO is an indicator of the strength of a match between the input signal and the music file, where a lower AVO indicates a stronger match.

The comparator preferably takes into account that the input signal may vary significantly from the corresponding music file. For example, the input signal tempo may be significantly faster or slower than the music file, it may have missing or added notes, and it may be from any portion of the music file. In a preferred embodiment, the comparator searches for a best match up between the input signal and the music file by modifying input signal tempo and by inserting a time offset in order to identify the closest match, as will be explained below.

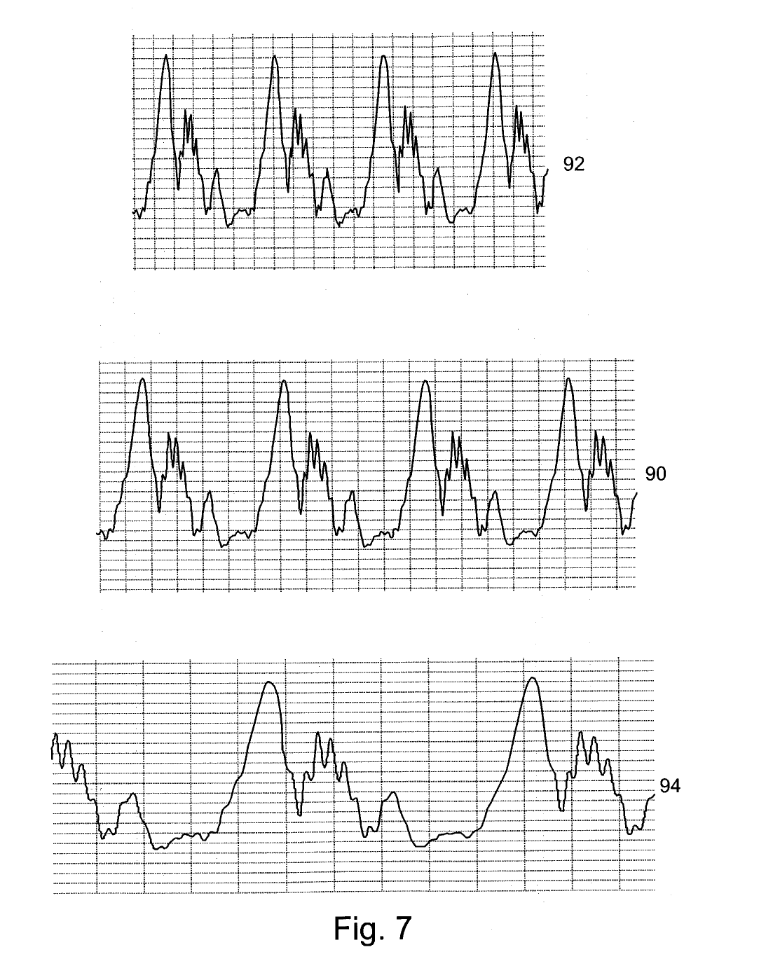

Reference is now made to FIG. 7, which illustrates an input signal, where the time dimension is stretched or condensed. Signal 90 depicts the signal at its original tempo. Signal 92 is similar to signal 90 but is at a more rapid tempo, and therefore its time dimension is condensed relative to the original tempo. Signal 94 is similar to signal 90 but is at a slower tempo, and therefore its time dimension is stretched relative to the original tempo. If the tempo of the information in the music file is at the tempo of signal 90, and the user version is at the more rapid tempo of signal 92, the comparator 8 may not detect a match. In a preferred embodiment, comparator 8 modifies the input signal information to adjust its tempo to be over a predetermined range of values. The modified input signal information is compared to the music file information to determine the strength of a match between the modified input signal and the music file information. For example, in order to determine a match between the condensed signal 92 and the music file information, the input signal tempo may be decreased before a comparison is performed.

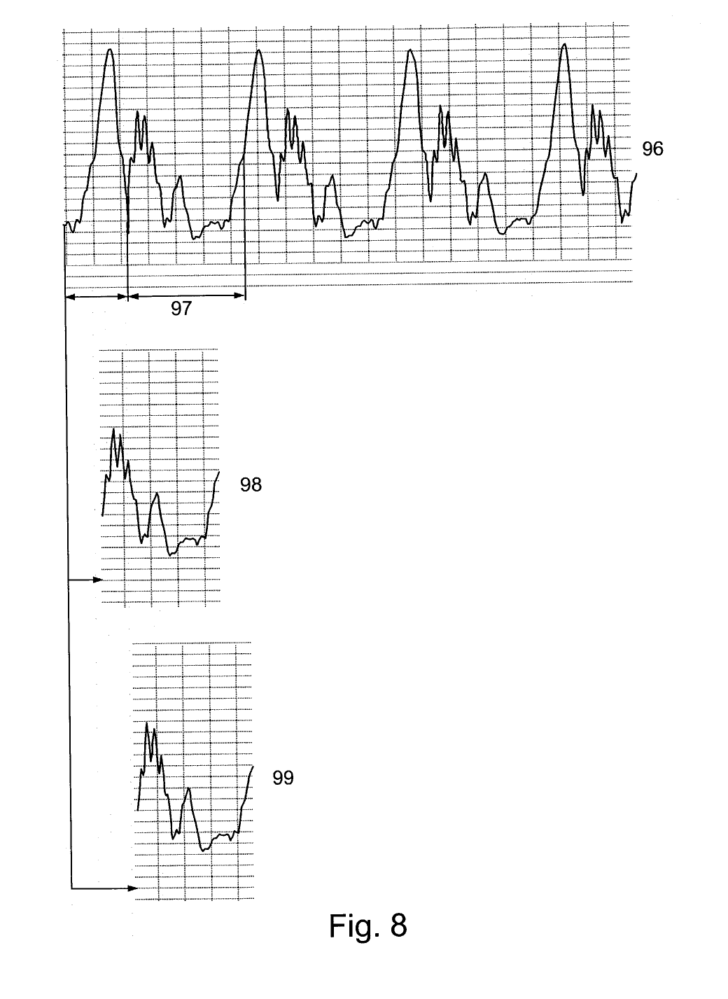

Reference is now made to FIG. 8, which illustrates how segments of a signal may be compared to a longer signal at different time offsets. Signal 96 is an audio signal. Segment 97 is a segment of signal 96 that is to be compared to the entire signal 96. Segments 98 and 99 illustrate segment 97 at different time offsets from the beginning of signal 96. When segments 98 or 99 are compared to signal 96, a close match will not be found unless the signal offset matches the location of segment 97 within signal 96. In the present case, segment 98 does not match signal 96, while segment 99 is a relatively good match.

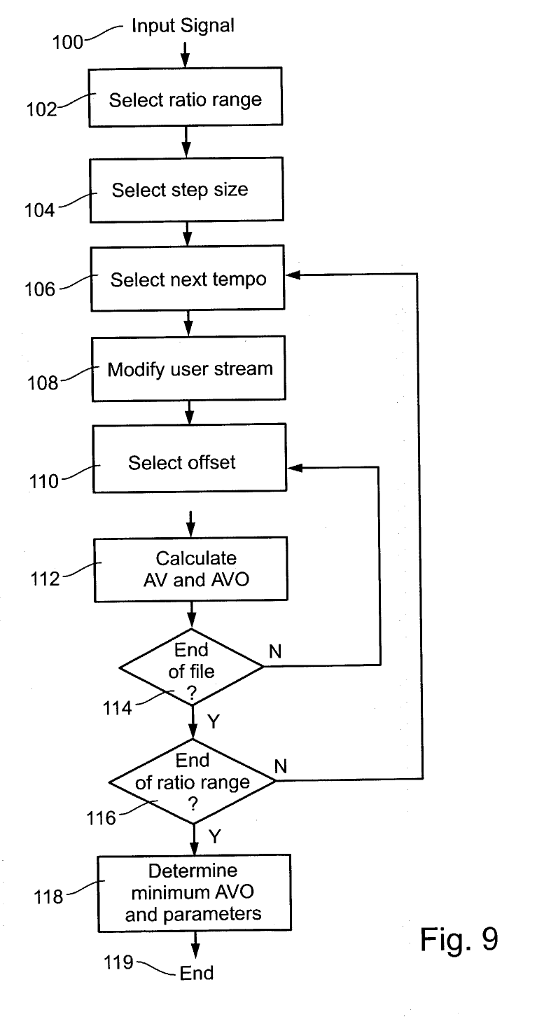

Reference is now made to FIG. 9, which is a simplified flow chart of a preferred embodiment of a comparison algorithm used by the comparator 8 to determine the strength of the match between an input signal and a given digital music file. The comparator 8 assumes that the ratio of input signal tempo to music file tempo falls within a certain range, for example, the input may be from four times slower to four times faster than the music file. The algorithm is performed twice. First an entire range of input signal tempos is checked in low resolution (large step size). The algorithm is then repeated in high resolution (small step size) over a sub-section of the range of input signal tempos, over the sub-section that was found to give the closest match during the low-resolution scan.

The input 100 to the comparison algorithm is preferably the frequency versus time information for both the input signal and the digital music file, as detected by the input signal and music file processors. The comparator first selects a range of input signal tempos to be checked in step 102. The comparator next selects a step size to use to step over the selected range in step 104. The specific input signal tempo being tested is selected in step 106. Next the input signal information is modified to generate a faster or slower signal according to the input signal tempo being tested in step 108. A time offset is selected in step 110. For each input signal tempo and time offset, the AV and AVO are calculated in step 112, as described above. The time offset is incremented until the end of the digital file is reached in step 114. If the end of the file is reached, and the comparator checks if the entire range of tempos has been checked in step 116. If the entire range has not been checked, the input signal tempo is changed in step 106 and the signal is rechecked against all signal offsets as before. If the entire range of input signal tempos and offsets has been checked, the parameters giving the minimal AVO are determined in step 118. The outputs of the algorithm are the input signal tempo and offset that give the closest match between the input signal and the given music file, and the resulting AV and AVO 119.

Once the best settings are determined at low resolution, input signal tempo is checked around the determined settings at high resolution (small jumps), to determine the input signal tempo and offset that gives the closest match between the input signal and the music file information. The AVO obtained at the present input signal tempo and offset is used to rate the strength of the match between the input signal and the given music file.

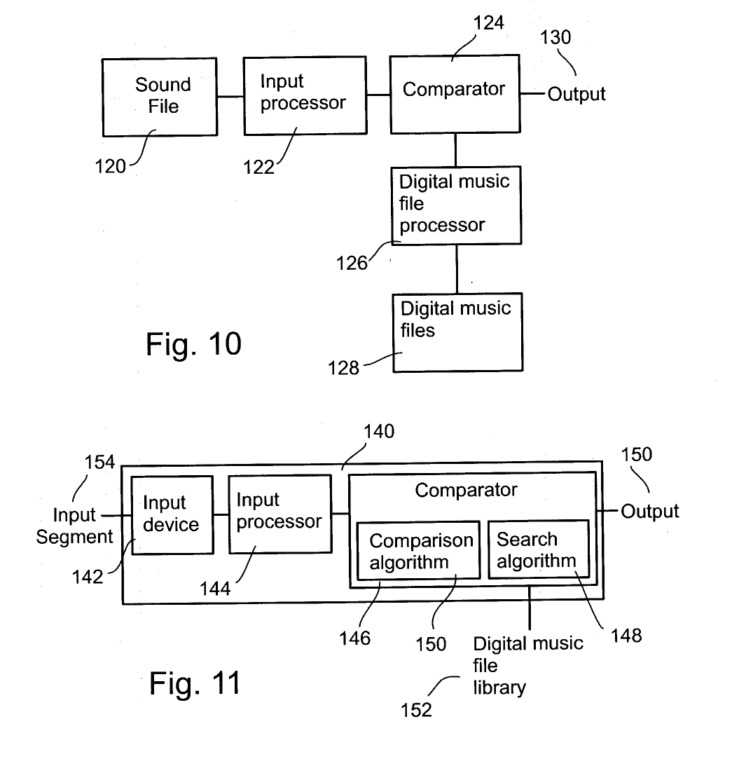

FIG. 10 is a simplified illustration of an embodiment in which the input signal is a computer sound file. Sound file 120 is a computer file containing a segment of music. Input processor 122 processes the segment according to the file type. The processed segment information is next input to comparator 124. Comparator 124 compares the segment information with the information obtained by the digital music file processor 126 from digital music files 128, and provides matching files as output 130. Both the input segment and the digital music files can be in any known audio format, such as wave, midi, or mp3. In the present embodiment the input file is located on a local computer. In another embodiment, the file is located on a networked computer.

FIG. 11 is a simplified illustration of a music files search engine. Music files search engine 140 is comprised of an input device 142, input processor 144, and comparator 146. Comparator 146 is preferably arranged to perform two basic algorithms: a search algorithm 148, and a comparison algorithm 150. Search engine 140 searches a digital music file library 152 to identify files that match input segment 154. The type of input segment determines which type of input device is required, for example, a microphone for auditory input. Input processor 144 extracts musical information from the input segment. Comparator 146 searches files in a digital music file library using known search algorithms 148. Comparator 146 applies a comparison algorithm 150 to music file library files, seeking files that correspond to the musical information extracted from the input by input processor 144. The files found to correspond to the input signal are the search engine output 156. In another embodiment the digital music files that are searched are distributed on a network, such as the Internet.

Ring tone files for many models of mobile telephones may be downloaded from central databases. However, the telephone owner must know the name of the ring tone to be downloaded. In a preferred embodiment of the music search engine, a portion of a ring tone is input into the search engine, for example the telephone owner hums or sings a portion of a ring tone, and the ring tone is then searched for by the music file search engine. Once located, the ring tone can be downloaded into the mobile telephone.

An alternate embodiment of the music search engine is as a karaoke search engine. Singers in karaoke clubs can quickly identify their desired background music by humming or singing a portion of a desired song. The music search engine searches the stored music files to identify the required background music, and plays the music.

In a preferred embodiment, the music search engine maintains a searchable database of music files. Parameters and information determined during analysis of a given music file, such as a ring tone file, during any portion of the search process may be stored in the music database, and may be used to facilitate the search process at a later stage.

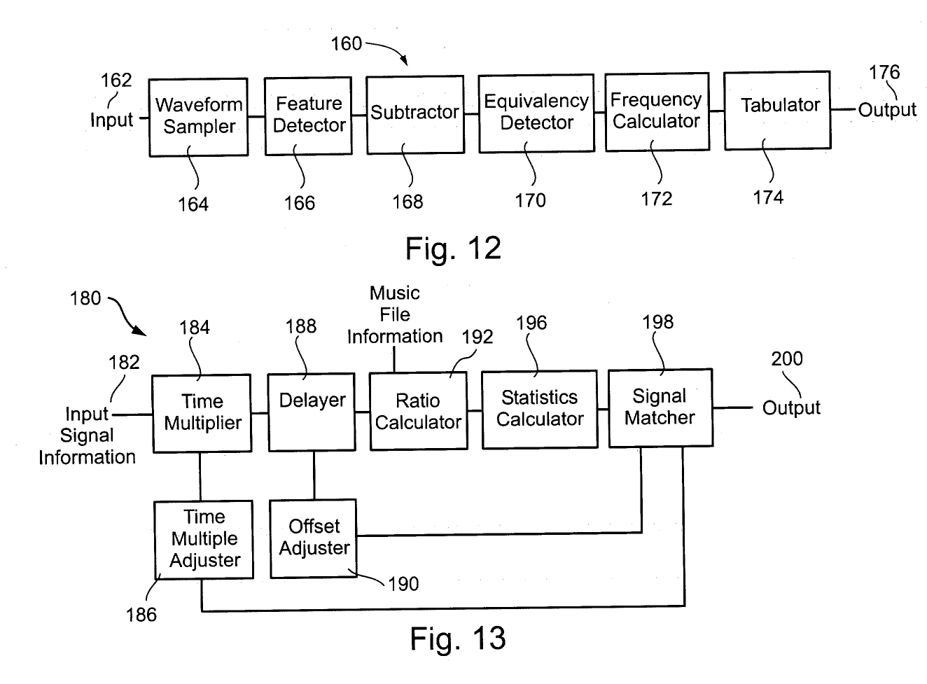

Reference is now made to FIG. 12, which is a simplified block diagram of a preferred embodiment of an apparatus 160 to determine the frequency of an input signal over time. Input signal 162 enters waveform sampler 164, which samples and digitizes the signal. Feature detector 166 divides the signal into intervals, and analyzes the sampled signal to detect repeating features in each interval and their times of occurrence. Subtractor 168 then calculates the difference of times of occurrence of successive repeating waveforms. Equivalency detector 170 analyzes the time differences to detect whether the waveforms recur at regular intervals. If so, frequency calculator 172 calculates the signal frequency from the differences of times of occurrence found by subtractor 170. Tabulator 174 compiles a listing of the input signal frequencies over the duration of the waveform, and provides this as output 176.

Reference is now made to FIG. 13, which is a simplified block diagram of a preferred embodiment of an apparatus for comparing the frequency versus time information of an input signal to the frequency information corresponding to a digital music file, in order to identify if the digital music file matches the input signal. The input signal information 182 first enters time multiplier 184, which multiplies it by a factor determined by time multiple adjuster 186. This serves to compress or stretch the input signal along the time dimension. The input signal information 182 then enters delayer 188, which delays it by a time offset determined offset adjuster 190. Ratio calculator 192 forms a ratio of the modified signal information to music file information 194 over time. Statistics calculator 196 calculates the statistical properties of this ratio, including the average ratio and the average offset of the calculated ratio from the average ratio. Signal matcher 198 uses the statistical properties to determine the quality of the match of the input signal information 182 and the musical file information 194.

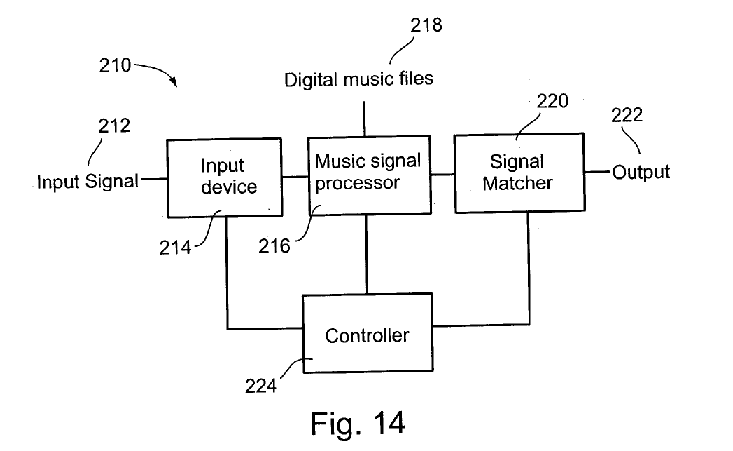

Reference is now made to FIG. 14, which is a simplified block diagram of a preferred embodiment of a music files search engine 210. Input signal 212 enters input device 214, which converts it into a form that serve as input into music signal processor 216. Music signal processor extracts basic music information from the signal obtained from the input device, and from the digital music file currently being examined 218. The current music file is one of a group of files being searched by the search engine 210. In a preferred embodiment the music file signal processor 216 is embodied by the device illustrated in FIG. 12, and described in greater detail above. Signal matcher 220 compares the information extracted by music file signal processor 216 from the input signal 214 and from the music file 218 being examined, and determines the files that match the input signal 212 most closely. In a preferred embodiment the signal matcher 220 is embodied by the device illustrated in FIG. 13, and described in greater detail above. Controller 224 controls all aspects of search engine performance, including the search algorithm used to proceed through the group of digital music files 218 being searched.

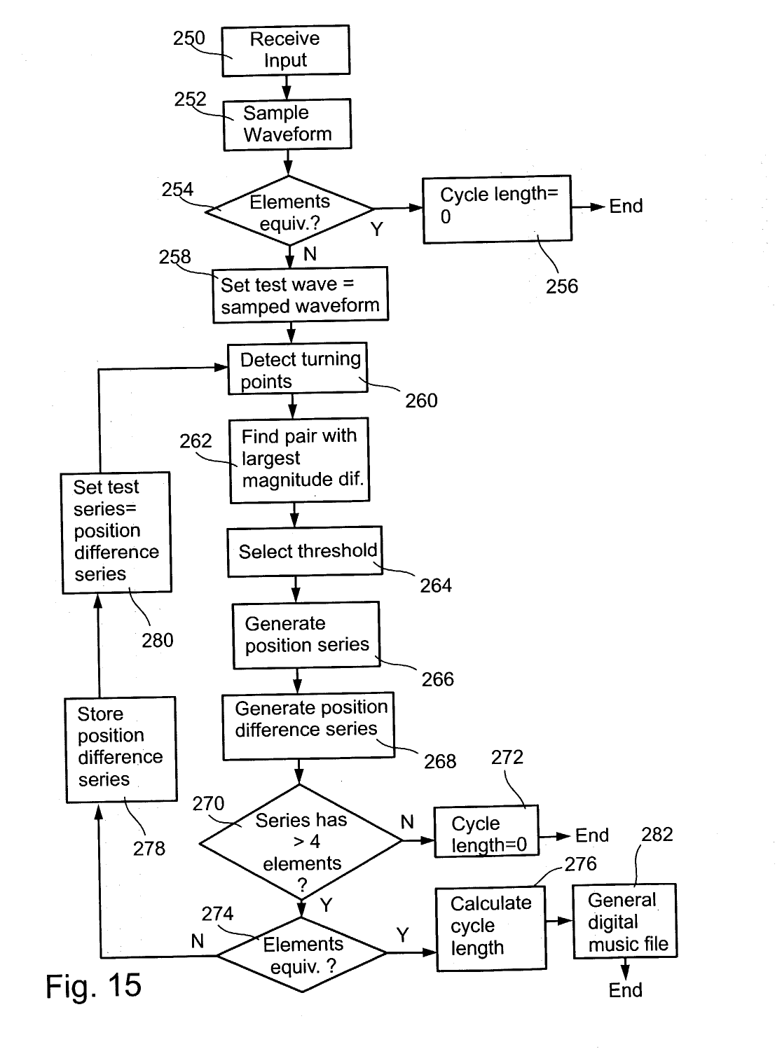

Reference is now made to FIG. 15, which is a simplified flow chart of a preferred embodiment of a method for generating a digital music file from an input signal. In step 250 an input signal bearing auditory information is received. The input signal may be generated by a variety of sources, such as a user, musical instrument, cellular telephone, personal digital assistant, or any other device or instrument capable of generating an audio signal or of generating a representation of an audio signal. The input signal is processed to extract input frequency versus time information in steps 252 to 280, as described above for the preferred embodiment of FIG. 4. In step 282 a digital music file is generated from the frequency versus time information extracted from the input signal. The preferred embodiment of FIG. 15 can process a user input, such as a user humming or singing, and generate a digital music file, such as a mobile telephone ring tone, from the user input. In a preferred embodiment, if the frequency extraction portion of the method terminates due to an inability to detect a cycled signal the user is notified that a digital music file cannot be generated from the current input. In a further preferred embodiment, the digital file generation step may be combined with a search procedure, so that a digital music file matching the user input is first searched for in existing databases, and if a match is not found a matching file is generated from the input.

A music file search engine, with the capability to search through a database of music files for a file that matches a passage hummed or sung by a user, can be of great benefit to music fans worldwide. Textual information is not required. The musical information of an input signal and of a music file may be extracted, modified as necessary, and compared. The input signal may come from any one of a plurality of sources. Likewise, the digital music files may be in any one of a plurality of formats. Comparison results may be analyzed statistically, to thereby determine the closeness of the match between the input and the music file. A music search engine can thus search a database of music files, whether on a local computer or on the Internet. With the growing proliferation of music available on the Internet, it appears that a music search engine can have a significant impact.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

In the claims below any reference to a computer refers to a plurality of computers connected together by means of shared communications.

We claim:

1. A method for detecting the presence of substantially repeating features in a waveform and determining the frequency of a waveform containing said features, comprising the steps of:
selecting a feature;
detecting the times of occurrence of said feature over a predetermined time interval;
calculating the differences of time of occurrence of a predetermined number of consecutive occurrences of said feature;
determining if said differences of time of occurrence are substantially equivalent using a predetermined criterion of equivalence;
determining that said feature is repetitive if said differences of time of occurrence are substantially equivalent; and,
if said feature is substantially repetitive, calculating the frequency of said waveform from the differences of time of occurrence.

2. A method for detecting the presence of substantially repeating features in a waveform and determining the frequency of a waveform containing said features according to claim 1, further comprising the step of:
sampling the waveform at a predetermined sample rate to determine the amplitude of the waveform at each sample time.

3. A method for detecting the presence of substantially repeating features in a waveform and determining the frequency of a waveform containing said features according to claim 1, where said feature is the waveform crossing one of a predetermined set of thresholds.

4. A method for detecting the presence of substantially repeating features in a waveform and determining the frequency of a waveform containing said features according to claim 1, where said feature is a waveform turning point.

5. A method for identifying computer digital music files that match an input signal bearing auditory information comprising the steps of:
receiving an input signal bearing auditory information;
processing said input signal to extract input frequency versus time information;
for each of said digital music files, processing the file to extract frequency versus time information; and
comparing the ratio of the input frequency information to the frequency information of respective digital music files over the duration of the input signal to thereby identify a digital music file that most closely matches said input signal.

6. A method for identifying digital music files according to claim 5, wherein the step of processing said input signal to extract input frequency versus time information further comprises:
sampling the waveform at a predetermined sample rate to determine the amplitude of the waveform at each sample time;
detecting the times of occurrence of a predetermined repeating feature over a predetermined time interval;
calculating the differences of time of occurrence of a predetermined number of consecutive occurrences of said feature;
determining if said differences of time of occurrence are substantially equivalent using a predetermined criterion of equivalence;
if said differences of time of occurrence are substantially equivalent, calculating the frequency of said time interval by dividing the difference of time of occurrence by the sample frequency; and,
compiling a listing of the frequency of said waveform against time for a duration of said waveform.

7. A method for identifying digital music files according to claim 5, wherein the step of processing said input signal to extract input frequency versus time information comprises:
sampling said waveform at a predetermined sample rate to generate a sampled waveform series of elements, each element comprising a magnitude of said input signal;
if said elements are of equivalent magnitudes, setting said cycle length equal to zero and discontinuing said frequency extraction process; and
if said elements are not of equivalent magnitudes, performing the steps of:
setting a test waveform equal to said sampled waveform series; and
performing a frequency extraction iteration cycle by:
detecting turning point elements of said test waveform vector at which said test waveform vector changes direction;
determining a pair of turning points having the largest difference in magnitude, such that no other turning point value falls between said pair of turning points;
selecting a threshold by calculating an average of said pair of turning points;
generating a position series, wherein each element of said position series is a position at which lines between successive pairs of elements of said test waveform cross said threshold, and wherein the order of said elements in said position series is preserved relative to said test waveform;
generating a position difference series, wherein each element of said position difference series comprises a difference between a respective pair of successive elements of said position series;
if said position difference sequence comprises fewer than five elements, setting said cycle length equal to zero and discontinuing said frequency extraction process;
if said position difference sequence comprises more than four elements and said elements are of equivalent magnitudes, calculating a cycle length of said sampled waveform and discontinuing said frequency extraction process; and
if said position difference sequence comprises more than four elements and said elements are not of equivalent magnitudes, continuing said frequency extraction process by performing the steps of:
storing said position difference series;
setting said test waveform series equal to said position difference series; and
performing a frequency extraction iteration cycle.

8. A method for identifying digital music files according to claim 7, wherein the step of calculating a cycle length of said sampled waveform comprises:
setting a proposed cycle length equal to two; and
performing a cycle length determination iteration by:
recursively calculating from the stored position difference series a number of sampled waveform elements represented by said proposed cycle length;
generating a test vector by subtracting one cycle of said sampled waveform series from a second cycle shifted by said proposed cycle length;
if said test vector is equivalent to a zero vector, discontinuing said cycle length calculation process by setting said cycle length equal to said number of sampled waveform elements; and
if said test vector is not equivalent to a zero vector, incrementing said proposed cycle length by one and performing another cycle length determination iteration.

9. A method for identifying digital music files according to claim 7, wherein said input signal comprises a sampled waveform series.

10. A method for identifying digital music files according to claim 7, further comprising determining a frequency of said input signal from said cycle length.

11. A method for identifying digital music files according to claim 5, wherein said input signal is generated by a user.

12. A method for identifying digital music files according to claim 5, wherein said input signal is generated by a user humming.

13. A method for identifying digital music files according to claim 5, wherein said input signal is generated by a user singing.

14. A method for identifying digital music files according to claim 5, wherein said input signal is generated by a musical instrument.

15. A method for identifying digital music files according to claim 5, wherein said input signal is a computer sound file.

16. A method for identifying digital music files according to claim 5, wherein said digital music files are located on a computer network.

17. A method for identifying digital music files according to claim 16, wherein at least one of said digital music files comprises a mobile telephone ring tone file.

18. A method for identifying digital music files according to claim 5, wherein the step of comparing the ratio of the input frequency information to the frequency information corresponding to each of said digital music files further comprises:
calculating the ratio between the input frequency to the digital music file frequency over the duration of said input;
calculating the average of said ratio and the deviation of said ratio from the average ratio; and,
determining the degree to which said input signal matches said digital music file, wherein a small deviation of said ratio indicates a strong match and a large deviation of said ratio indicates a weak match.

19. A method for identifying digital music files according to claim 5, wherein the step of comparing the ratio of the input frequency information to the frequency information corresponding to each of said digital music files further comprises:
multiplying the time dimension of the input frequency versus time information by a predetermined factor.

20. A method for identifying digital music files according to claim 19, wherein the step of multiplying the time dimension of the input frequency versus time information by a predetermined factor further comprises:
for each digital music file, varying said predetermined factor to identify an optimal factor that results in the closest match between said modified input signal information and said music file.

21. A method for identifying digital music files according to claim 20, wherein the step of comparing the ratio of the input frequency information to the frequency information corresponding to each of said digital music files further comprises:
for each digital music file, multiplying the time dimension of the input frequency versus time information by the optimal factor for said digital music file.

22. A method for identifying digital music files according to claim 5, wherein the step of comparing the ratio of the input frequency information to the frequency information corresponding to each of said digital music files further comprises:
delaying said input frequency versus time information by a predetermined offset.

23. A method for identifying digital music files according to claim 22, wherein the step of delaying said input frequency versus time information by a predetermined offset further comprises:
for each digital music file, varying said predetermined offset to identify an optimal offset that results in the closest match between said modified input signal information and said music file.

24. A method for identifying digital music files according to claim 23, wherein the step of comparing the ratio of the input frequency information to the frequency information corresponding to each of said digital music files further comprises:
for each digital music file, delaying said input frequency versus time information by the optimal offset for said digital music file.

25. A method for identifying digital music files according to claim 5, wherein said input signal serves as a search parameter for a music files search engine that identifies digital music files that match the input signal.

26. A method for identifying digital music files according to claim 5, further comprising the step of:
processing said digital music files to automatically extract musical note versus time information.

27. A method for identifying digital music files according to claim 26, further comprising the step of:
processing said input signal to extract input musical note versus time information.

28. A method for identifying digital music files according to claim 27, further comprising the step of:
comparing said input musical note versus time information with musical note versus time information corresponding to said digital music files to thereby identify a digital music file that matches said input signal.

29. A method for identifying digital music files according to claim 5, wherein said input signal is compared to musical scores associated with the digital music files.

30. A method for identifying digital music files according to claim 5, wherein a best match comparison is performed between said input signal and said digital music files, to determine the closest match.

31. A method for identifying digital music files according to claim 18, wherein the comparison between said input signal and said digital music files produces a list of files wherein said list indicates the degree to which the files match.

32. A method for identifying digital music files according to claim 30, wherein the comparison between said input signal and said digital music files produces a list of files wherein said list indicates the degree to which the files match.

33. A method for identifying digital music files that match a computer file, wherein said computer file represents a segment of a musical score, comprising the steps of:
processing said computer file to extract frequency versus time information;
processing said digital music files to extract frequency versus time information; and,
comparing said frequency versus time information corresponding to said computer file to frequency versus time information corresponding to said digital music files to thereby identify a digital music file that matches said segment of a musical score.

34. A method for generating a digital music file, comprising the steps of:
receiving an input signal bearing auditory information;
processing said input signal to extract input frequency versus time information by:
sampling said waveform at a predetermined sample rate to generate a sampled waveform series of elements, each element comprising a magnitude of said input signal;
if said elements are of equivalent magnitudes, setting said cycle length equal to zero and discontinuing said frequency extraction process; and
if said elements are not of equivalent magnitudes, performing the steps of:
setting a test waveform equal to said sampled waveform series; and
performing a frequency extraction iteration cycle by:
detecting turning point elements of said test waveform vector at which said test waveform vector changes direction;
determining a pair of turning points having the largest difference in magnitude, such that no other turning point value falls between said pair of turning points;
selecting a threshold by calculating an average of said pair of turning points;
generating a position series, wherein each element of said position series is a position at which lines between successive pairs of elements of said test waveform cross said threshold, and wherein the order of said elements in said position series is preserved relative to said test waveform;
generating a position difference series, wherein each element of said position difference series comprises a difference between a respective pair of successive elements of said position series;
if said position difference sequence comprises fewer than five elements, setting said cycle length equal to zero and discontinuing said frequency extraction process;
if said position difference sequence comprises more than four elements and said elements are of equivalent magnitudes, calculating a cycle length of said sampled waveform and discontinuing said frequency extraction process; and
if said position difference sequence comprises more than four elements and said elements are not of equivalent magnitudes, continuing said frequency extraction process by performing the steps of:
storing said position difference series;
setting said test waveform series equal to said position difference series; and
performing a frequency extraction iteration cycle; and
generating a digital music file from said frequency versus time information extracted from said input signal.

35. A method for generating a digital music file according to claim 34, wherein said input signal is generated by a user.

36. A method for generating a digital music file according to claim 35, wherein said input signal is generated by a user humming.

37. A method for generating a digital music file according to claim 35, wherein said input signal is generated by a user singing.

38. A method for generating a digital music file according to claim 34, wherein said digital music files comprises a mobile telephone ring tone file.

39. An apparatus for detecting the presence of substantially repeating features in a waveform and determining the frequency of a waveform containing said features, comprising:
a waveform sampler operable to sample the waveform at a predetermined sample rate to determine the amplitude of the waveform at each sample time;
a feature detector operable to detect times of occurrence of repeating features over a predetermined time interval;
a subtractor operable to calculate differences between successive ones of said times of occurrence;
an equivalency detector operable to determine if said differences of time of occurrence are substantially equivalent using a predetermined criterion of equivalence, and thereby determine that said features are substantially repetitive if said differences of time of occurrence are substantially equivalent; and,
a frequency calculator operable to calculate the frequency of said time interval by dividing the difference of time of occurrence by the sample frequency.

40. An apparatus for detecting the presence substantially repeating features in a waveform and determining the frequency of a waveform containing said features according to claim 39, further comprising:
a tabulator operable to compile a listing of the frequency versus time information of said waveform for the entire duration of said waveform.

41. An apparatus for detecting the presence substantially repeating features in a waveform and determining the frequency of a waveform containing said features according to claim 39, wherein said waveform is stored on a computer file.

42. An apparatus for comparing the frequency versus time information of an input signal to the frequency information corresponding to a digital music file over the duration of the input signal to thereby identify if said digital music file matches said input signal, comprising:
a ratio calculator operable to calculate the ratio of the input frequency information to the frequency information corresponding to said digital music file over the duration of the input signal;
a statistics calculator operable to calculate an average of said ratio and a deviation of said ratio from the average ratio; and
a signal matcher operable to determine the degree to which said input signal matches said digital music file, wherein a small deviation of said ratio from said average indicates a strong match and a large deviation of said ratio from said average indicates a weak match.

43. An apparatus for comparing the frequency versus time information of an input signal to the frequency information corresponding to a digital music file according to claim 42, further comprising:
a time multiplier operable to multiply the time dimension of the input signal frequency versus time information by a predetermined factor; and
a time multiple adjuster operable to vary said factor to identify an optimal factor that results in the closest match between said modified input signal information and said music file.

44. A apparatus for comparing the frequency versus time information of an input signal to the frequency information corresponding to a digital music file according to claim 42, further comprising:
a delayer operable to delay the time dimension of the input signal frequency versus time information by a predetermined offset; and
an offset adjuster operable to vary said offset to identify an optimal offset that results in the closest match between said modified input signal information and said music file.

45. A music files search engine, comprising:
an input device for obtaining an input signal;
a music signal processor operable to extract musical information; and
a signal matcher operable to determine the degree to which extracted input signal musical information matches extracted digital music file musical information;
and wherein the music files search engine is operable to search a plurality of music files for the files that match the input signal most closely.

46. A music files search engine according to claim 45, wherein the digital music files are located on a computer network.

47. A music files search engine according to claim 45, wherein at least one of said digital music files comprises a mobile telephone ring tone file.
